(19) United States
(12) Patent Application Publication
(10) Pub. No.: US 2021/0347576 A1
(43) Pub. Date: Nov. 11, 2021

(54) CONVEYOR LINE FOR A CONVEYOR

(71) Applicant: Aumund Fördertechnik GmbH, Rheinberg (DE)

(72) Inventor: Christian Kirschniok, Moers (DE)

(21) Appl. No.: 17/283,993

(22) PCT Filed: Oct. 4, 2019
(86) PCT No.: PCT/EP2019/076858

§ 371 Date: Apr. 9, 2021

(30) Foreign Application Priority Data
Oct. 9, 2018 (DE) 10 2018 124 850.4

(51) Int. Cl. B65G 17/42; B65G 17/32; F16G 15/12

(52) U.S. Cl. CPC B65G 17/42; F16G 15/12; B65G 17/32

(57) ABSTRACT

The present invention relates to a conveyor line (1) comprising at least one link plate chain (2), which consists of a plurality of chain links (3a, 3b) each with two link plates (4, 5), wherein at least one chain link (3a, 3b) comprises a bracket (angled holder) (9a, 9b) with a fastening section (10), and at least one conveying means (11), which can be fastened by a fastener via an assembly section (12) to the bracket (angled holder) (9a, 9b).

The present invention relates to a conveyor line, comprising at least one link plate chain, which consists of a plurality of chain links each having two link plates, wherein at least one chain link comprises a bracket (angled holder, German: Winkelhalter) with a fastening section, and at least one conveying means, which is/can be fastened by means of a fastener via an assembly section on the fastening section of the bracket (angled holder).

For example, a link plate chain of such a conveyor line is known from EP 1 592 898 B1, in which an individual link plate of a link plate has arranged on it a bracket (angled holder), which bracket (angled holder) with its fastening section is outwardly angled away from the longitudinal axis of the link plate chain. Holes are formed in the fastening section as fastening elements, through which a rivet or a screw is passed as a fastener for fastening a conveying means in the manner of a bucket, a plate, or a cell. To this end, for example, the assembly section of the conveying means has connecting elements in the form of holes, which must be aligned to the fastening element of the bracket (angled holder), so as to secure the fastener.

For link plate chains of varying size, which differ from each other in terms of link plate and bracket (angled holder) dimensions, the connection dimensions for the conveying means also vary. In particular, the distance between the fastening element in the fastening section of the bracket (angled holder) and a central longitudinal axis of the link plate chain changes. However, this means that the assembly section of the conveying means must also be adjusted accordingly for each size of a link plate chain. In the case of link plate chains which differ in size with respect to the chain links, conveying means must be manufactured or provided that differ from each other in how their connecting elements are arranged.

In order to assemble the complete conveyor line, the assembly section of the conveyor must be exactly propositioned relative to the fastening section of the bracket (angled holder) until the fastener in the form of a screw or a rivet has been passed through the corresponding holes in the assembly section and the fastening section, which makes assembly more difficult.

Therefore, the object of the present invention is to eliminate the disadvantages described with reference to prior art, and in particular to indicate a conveyor line which has been made easier to assemble. In addition, a modular production of conveyor lines with link plate chains of varying size is to be simplified.

The object is achieved by a conveyor line with the features of the independent claim. Advantageous further developments of the conveyor line are indicated in the dependent claims and in the specification, wherein individual features of the advantageous further developments can be combined with each other in any technically feasible manner desired.

The object is achieved by a conveyor line with the features mentioned at the outset, in which an alignment element is formed on the fastening section of the bracket angled holder) and/or on the assembly section, so that the assembly section and in particular the conveying means can be positioned in a predetermined manner relative to the bracket (angled holder) prior to fastening by the fastener.

The underlying idea of the invention thus provides that the fastening section of the bracket (angled holder) and/or the assembly section be shaped and/or designed in such way that, before being fastened by means of the fastener, the assembly section can initially be placed on the fastening section of the bracket (angled holder) in a manner defined by the alignment element and preferably also be held in this position for as long as no additional forces act on the assembly section. Due to the alignment element, no additional effort must be expended to hold the assembly section in the desired position while fastening the fastener.

For example, the alignment element can be designed as a recess, a depression, an elevation, or a projection in or on the fastening section and/or the assembly section. For example, the assembly section could have a depression as the alignment element, whose shape corresponds at least sectionally to the outer contour of the fastening section of the bracket (angled holder), so that the depression defines the alignment of the assembly section on the fastening section of the bracket (angled holder). However, it is preferred that the alignment element be formed on the assembly section, and that a corresponding

alignment element be formed on the bracket (angled holder), in particular on a fastening section of the bracket (angled holder). Therefore, both the assembly section and the fastening section of the bracket (angled holder) then have mutually corresponding alignment elements. In particular, the corresponding alignment element comprises a shape design complementary to the alignment element. For example, if the alignment element consists of a projection, the corresponding alignment element would consist of a correspondingly shaped depression or recess.

In a preferred embodiment, the alignment element is formed by an elevation surrounding a hole, which in the aligned state engages into another hole complementary to the elevation, wherein the fastener in the fastened state is passed through both holes. Pre-centering thus takes place directly in the area in which the fastening section of the bracket (angled holder) is connected with the assembly section by means of the fastener.

For example, the fastener can be designed as a screw or a rivet.

In particular, the conveying means is designed as a bucket, a plate, or a cell.

In particular, the assembly section can be integrally formed, and thus integrated into the conveying means itself. However, it can also be provided that the assembly section be formed on an element with which the conveying means can be or is frictionally, positively and/or materially connected.

In particular, the link plate chain is designed with several chain links alternatingly and pivotably arranged relative to each other, wherein a bolt of a chain link is rotatably arranged inside of a bush of an adjacent chain link. Therefore, the link plate chain is in particular a bush conveyor chain.

For example, the preferably closed loop link plate chain can consist of alternatingly arranged outer chain links and inner chain links, wherein the two respective bolts non-rotatably connected with the outer link plates of an outer chain link are arranged inside one of two bushes non-rotatably connected with the inner link plates of the adjacent inner chain links. Alternatively, however, the link plate chain can also be designed as a cropped chain, in which each chain link has a bolt non-rotatably connected with the link plates, and a bush non-rotatably connected with the link plates, wherein the bolt of a chain link is arranged in the bush of an adjacent chain link. Therefore, a chain link comprises in particular either two bushes, two bolts or one bush and one bolt.

In particular, the link plate chain is configured over a partial section comprising several chain links as a stiffened chain strand, so that adjacent chain links of the chain strand or the entire chain can pivot freely relative to each other for deflection in a circulating direction, wherein a pivoting motion in the direction opposite the circulating direction is limited in a manner known in the art, for example by forming stops/counter-stops on adjacent chain links.

It is also proposed that the fastening section of the bracket (angled holder) arranged on the first link plate be inwardly directed in the direction of second link plate, meaning toward the interior of the link plate chain.

A fastening section of the bracket (angled holder) having a fastening element in the form of a connecting bore, a hole, or a pin can be arranged between the two link plates, and hence in particular inside or above/below a central longitudinal axis of a link plate chain consisting of the chain links. This means that, even given varyingly dimensioned link plates and bracket (angled holders), the fastening element of a chain link or all fastening elements of all chain links can always be centrally arranged between the link plates. The corresponding assembly sections of the conveying means must thus not be adjusted with the connecting dimensions of their connecting elements to varyingly sized link plate chains, since the relative position of the fastening elements to the central longitudinal axis of the link plate chain does not change with a change in link plate chain size. In particular, this is achieved when the fastening element is centrally arranged between the two link plates.

It can be provided that the bracket (angled holder) be designed as a single piece with the link plate. For example, the bracket (angled holder) could already be correspondingly designed while forging, casting, or stamping the link plate. Alternatively, the bracket (angled holder) can be correspondingly designed by forming (bending) the initially flat link plate.

Alternatively, it can be provided that the bracket (angled holder) be fastened to the first link plate as a separate component. A corresponding bracket (angled holder) could be positively, frictionally and/or materially secured to the exterior side or interior side of the first link plate, for example screwed, riveted, or welded. As a consequence, the bracket (angled holder) could also even be secured to a link plate chain subsequently. It could also be provided that a corresponding bracket (angled holder) be fastened to the corresponding link plate in the area of the bush/bolt.

It can additionally be provided that both the first link plate and the second link plate each have arranged on them a bracket (angled holder), the fastening sections of which are preferably each directed in the direction of the other link plate. The fastening sections of the bracket (angled holder)s arranged on the opposing link plates are arranged one after the other in particular in the longitudinal direction of the chain link. Arranging bracket (angled holders) on both link plates distributes the force acting on the chain link more evenly.

In particular, the bracket (angled holder) is the section of the chain link that extends originating from a link plate to a fastening section, which is arranged roughly parallel to a plane of the chain link spanned by the bushes/bolts.

The brackets (angled holders) thus preferably extend from the respective first link plate in the direction of the opposing link plate, but in particular are not directly/immediately connected in any way with the opposing (second) link plate, since this would entail an additional assembly effort.

To the extent basically sufficient that each link plate only consist of precisely one individual link plate, an embodiment can also provide that a link plate be composed of two or more individual link plates, wherein at least one individual link plate of the first link plate is provided with the bracket (angled holder).

To achieve a uniform force distribution, it can now be provided that adjacent chain links each have a bracket (angled holder) on link plates arranged oppositely in relation to the longitudinal axis of the link plate chain. Alternatively, it can be provided that adjacent chain links each have a bracket (angled holder) on the link plates arranged on the same side in relation to the link plate chain longitudinal axis.

Further proposed as well is a conveyor, in particular a steel link belt, a bucket elevator or a cell bucket elevator with a conveyor line according to the invention, wherein the conveyor line is closed to a loop. In particular, the conveyor line also has rollers or guides, with which the conveyor line is guided on a corresponding guide (for example, rail) or on corresponding roller of the conveyor.

The invention along with the technical background will be exemplarily described below based on the figures. Shown schematically on

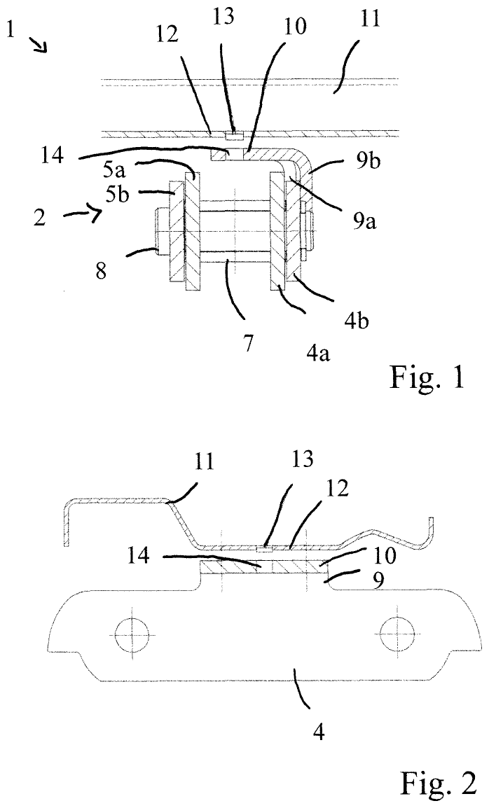

FIG. 1: is a cross section through a conveyor line,

FIG. 2: is a side view of a link plate of a link plate chain and a conveying means of a conveyor line,

FIG. 3: is a top view of a first embodiment of a link plate chain,

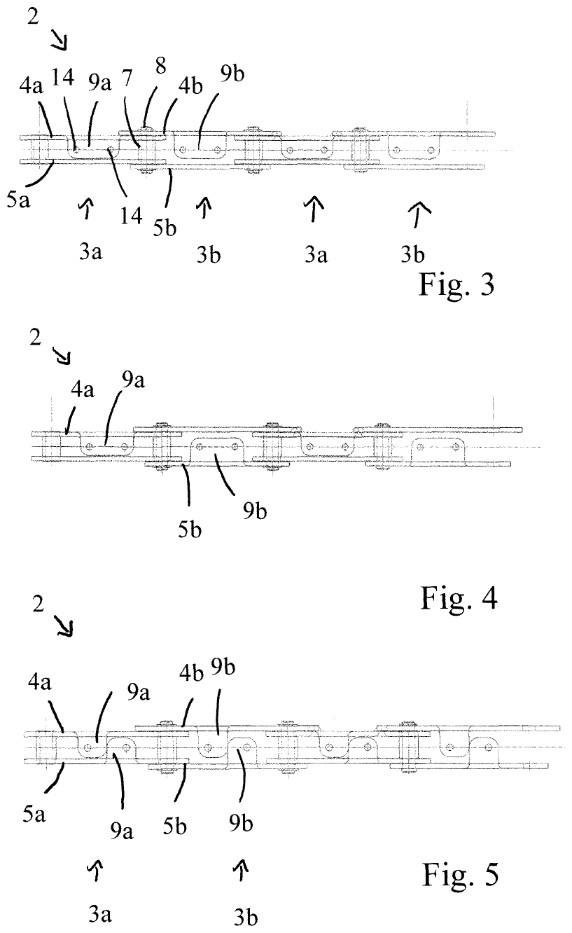

FIG. 4: is a top view of a second embodiment of a link plate chain,

FIG. 5: is a top view of a third embodiment of a link plate chain, and

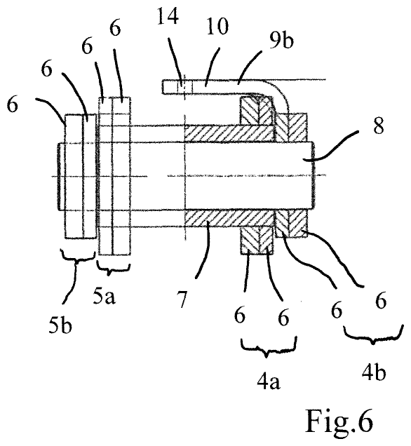

FIG. 6: is a partial cross sectional view through another embodiment of a link plate chain.

FIG. 1 shows a conveyor line 1 with a link plate chain 2 and a conveying means 11, The conveying means 11 is exemplarily shown as a belt mat, and comprises an assembly section 12 with a connecting element having an alignment element 13. The alignment element 13 is designed as an elevation surrounding a hole.

The link plate chain 2 comprises an inner chain link 3a and an outer chain link 3b. The inner chain link 3a has a first link plate 4a and a second link plate 5a. The inner chain link 3a further comprises two bushes 7, which are each non-rotatably connected with the first link plate 4a and the second link plate 5a, and space the latter apart from each other.

The outer chain link 3b comprises a first link plate 4b and a second link plate Sb. The first link plate 4b and the second link plate 5b are non-rotatably connected with each other and spaced apart from each other by two belts 8, wherein the bolts 8 are each rotatably arranged inside a bush 7 of an adjacent inner chain link 3a. The link plates 4, 5 of an inner chain link 3a and an adjacent outer chain link 3b thus overlap each other.

A separate bracket (angled holder) 9a is secured to the first link plate 4a of the inner chain link 3a, and a separate bracket (angled holder) 9b is formed on the first link plate 4b of the outer chain link 3b. The brackets (angled holders) 9a, 9b each have a fastening section 10, which is directed in the direction of the opposing second link plate 5a, 5b, and thus extends over a central longitudinal axis of the link plate chain 2. A hole 14 is formed in the fastening section 10, which serves as a fastening element for a fastener (not shown), and as a complementary alignment element for the alignment element 13. Accordingly, the shape of the hole 14 corresponds to the design of the elevation of the alignment element 13 of the conveying means 11. A fastener (not shown) in the form of a screw or rivet can be guided through the hole of the alignment element 13 and the hole 14. The alignment element 13 and the hole 14 allow the conveying means 11 to be easily held in the desired alignment relative to the link plate chain 2 prior to fastening, so that the expense for fastening can be diminished.

Since the hole 14 of a bracket (angled holder) 9 can be arranged centrally between the link plates 4, 5, the dimensioning of the assembly section 12 of the conveying means 11 need not be changed given a change in the dimensioning of the chain links 3 of a link plate chain 2.

FIG. 2 shows another embodiment of a link plate 4. As evident, a bracket (angled holder) 9 is integrally designed with the link plate 4. Otherwise, the embodiment on FIG. 2 corresponds to the embodiment of FIG. 1.

FIGS. 3 to 5 show top views of different link plate chains which differ from each other in the arrangement of bracket (angled holders) 9. The link plate chains 2 consist of inner chain links 3a and outer chain links 3b, as were already described in more detail with reference to FIG. 1.

According to FIG. 3, the bracket (angled holders) 9a, 9b of adjacent inner chain links 3a and outer chain links 3b are arranged on the same side of the link plate chain 2.

By contrast, the bracket (angled holders) 9a and 9b of adjacent inner chain links 3a and outer chain links 3b according to the embodiment of FIG. 4 are alternatingly arranged on opposing sides relative to the longitudinal direction of the link plate chain L.

According to FIG. 5, both the first link plate 4a, 4b and the second link plate 5a, 5b of both the inner chain links 3a and the outer chain links 3b each in turn have one bracket (angled holder) 9a, b.

If the embodiments of the link plate chains described above each only have one individual link plate as the link plate, the link plates 5a, 5b, 4a, 4b according to the embodiments on FIG. 6 are each comprised of two individual link plates 6, of which only one individual link plate 6 comprises a bracket (angled holder) 9b.

### REFERENCE LIST

1 Conveyor line
2 Link plate chain
3a Inner chain link
3b Outer chain link
4a, b First link plate
5a, b Second link plate
6 Individual link plate
7 Bush
8 Bolt
9a, b Bracket (angled holder)
10 Fastening section
11 Conveying means
12 Assembly section
13 Alignment element
14 Hole

1. Conveyor line (1), comprising:
at least one link plate chain (2), which consists of a plurality of chain links (3a, 3b) each with two link plates (4, 5), wherein at least one chain link (3a, 3b) comprises a bracket (9a, 9b) with a fastening section (10), and
at least one conveying means (11), which can be fastened by a fastener via an assembly section (12) to the bracket (9a, 9b), characterized in that an alignment element (13) is formed on the bracket (9a, 9b) and/or on the assembly section (12), so that the assembly section (12) can be positioned in a predetermined manner relative to the bracket (9a, 9b) prior to fastening by the fastener.

2. The conveyor line (1) according to claim 1, wherein the alignment element (13) is formed on the assembly section (12), and a corresponding alignment element (14) is formed on the bracket (9a, 9b), in particular on the fastening section (10) of the bracket (9a, 9b).

3. The conveyor line (1) according to claim 1, wherein the alignment element (13) comprises a recess, depression, elevation, or a projection.

4. The conveyor line (1) according to claim 2, wherein the corresponding alignment element (14) has a shape design complementary to the alignment element (13).

5. The conveyor line (1) according to claim 1, wherein the alignment element (13) is formed by an elevation surrounding a hole, which in the aligned state engages into another hole (14) complementary to the elevation, and wherein the fastener in the fastened state is passed through both holes.

6. The conveyor line (1) according to claim 1, wherein the fastener comprises a screw or a rivet.

7. The conveyor line (1) according to claim 1, wherein the conveying means (11) is designed as a bucket, a plate, or a cell.

8. A conveyor, in particular a bucket elevator or steel link belt with a conveyor line according to claim 1, which forms a closed loop.

9. The conveyor line (1) according to claim 1, wherein the alignment element (13) is formed on the assembly section (12), and a corresponding alignment element (14) is formed on the bracket (9a, 9b), in particular on the fastening section (10) of the bracket (9a, 9b), wherein the alignment element (13) comprises a recess, depression, elevation, or a projection, and further wherein the corresponding alignment element (14) has a shape design complementary to the alignment element (13).
